(19) United States
(12) Patent Application Publication
(10) Pub. No.: US 2026/0126273 A1
(43) Pub. Date: May 7, 2026

(54) TEMPERATURE-SENSITIVE INFRARED RADIATION ACTIVE CONTROL SHEET

(71) Applicant: INDUSTRY-ACADEMIC COOPERATION FOUNDATION, YONSEI UNIVERSITY, Seoul (KR)

(72) Inventors: Hyung Hee CHO, Seoul (KR); Joon Soo LIM, Seoul (KR); Nam Kyu LEE, Anyang-si (KR); In Joong CHANG, Seoul (KR); Ju Yeong NAM, Seoul (KR); Jin Sup SONG, Seoul (KR); Jae Hyeong KIM, Geoje-si (KR)

(21) Appl. No.: 19/379,410

(22) Filed: Nov. 4, 2025

(30) Foreign Application Priority Data
Nov. 4, 2024 (KR) 10-2024-0154081
Oct. 17, 2025 (KR) 10-2025-0150165

(51) Int. Cl. F41H 3/02; G02F 1/01

(52) U.S. Cl. CPC F41H 3/02; G02F 1/0147

(57) ABSTRACT

An embodiment relates to a technology capable of implementing a camouflage effect in the visible light range and also in the infrared range due to temperature rise, while controlling the camouflage effect. A temperature-sensitive infrared radiation active control sheet according to the embodiment includes: blocks formed of vanadium oxide; and a substrate formed under the blocks.

### CROSS REFERENCE TO RELATED APPLICATIONS

This application claims priority from Korean Patent Application No. 10-2024-0154081, filed on Nov. 4, 2024, and Korean Patent Application No. 10-2025-0150165, filed on Oct. 17, 2025, in the Korean Intellectual Property Office, which is incorporated herein by reference in its entirety.

### BACKGROUND

The disclosure relates to a temperature-sensitive infrared radiation active control sheet, and more particularly, to a technology capable of implementing a camouflage effect in the visible light region and simultaneously implementing a camouflage effect in the infrared region due to a temperature increase, and performing control over the camouflage effect.

An infrared camouflage technology is a crucial technology for enhancing survivability and operational success by reducing the detectability of friendly military operational systems to enemy detection systems.

Infrared detection primarily operates in the infrared band (8-12 μm) at low temperatures and in the mid-infrared band (3-5 μm) at high temperatures, and active research is being conducted to reduce infrared radiation signals within the detection band to implement infrared camouflage technology.

Recent advancements in infrared detection sensors and AI-based analysis technologies are now capable of analyzing and identifying infrared signals in image form, rendering existing infrared camouflage techniques ineffective.

Therefore, to overcome the limitations of uniform camouflage techniques, proactively creating infrared camouflage patterns is necessary. However, simultaneously implementing camouflage patterns in the visible range is challenging.

In Korean Patent No. 10-2018-0105109 (Title of invention: CAMOUFLAGE DEVICE), a camouflage device is disclosed that includes a paint layer applied to the camouflage device so that the camouflage color changes to a required color depending on moisture or temperature depending on the operating conditions of the camouflage device.

### RELATED ART DOCUMENTS

### Patent Document

Republic of Korea Patent No. 10-2018-0105109

### SUMMARY

An aspect of the disclosure is to provide a technology that can achieve a camouflage effect in the visible light range and also in the infrared range due to temperature increase, and can control the camouflage effect.

The aspect of the disclosure is not limited to that mentioned above, and other aspects not mentioned will be clearly understood by those skilled in the art from the description below.

To this end, the disclosure includes: blocks formed of vanadium oxide; and a substrate formed under the blocks, wherein one of the plurality of blocks has different thicknesses from another block.

In an embodiment of the disclosure, the plurality of blocks may form a camouflage pattern.

In an embodiment of the disclosure, one block and another block among the plurality of blocks may have the same thickness.

In an embodiment of the disclosure, the thickness of the blocks may be 50 to 400 nanometers (nm).

In an embodiment of the disclosure, when the temperature of the plurality of blocks is equal to or higher than the transition temperature, infrared radiation signals of one block and another block among the plurality of blocks may be different from each other.

In an embodiment of the disclosure, when the temperature of the plurality of blocks is lower than the transition temperature, colors of one block and another blocks among the plurality of blocks may be different from each other.

In an embodiment of the disclosure, depending on the temperature of the blocks, a camouflage pattern in a visible area and a camouflage pattern in an infrared area may be switched and expressed.

In an embodiment of the disclosure, the disclosure may further include a base plate formed under the substrate.

In an embodiment of the disclosure, the substrate may be formed of quartz, aluminum oxide (Al₂O₃) or silicon dioxide (SiO₂).

In an embodiment of the disclosure, the base plate may be formed of a flexible material.

In an embodiment of the disclosure, a combination of one substrate and one block may be formed, and a plurality of combinations may be arranged on the base plate.

In an embodiment of the disclosure, the surface shape of the blocks may be formed in a polygon, circle or ellipse.

The effect of the disclosure is that the infrared pattern can be changed in real time based on temperature, while simultaneously a camouflage pattern can be implemented in the visible range with color change characteristics based on thickness, so that it is possible to significantly enhance the camouflage effect in each optical region.

Furthermore, the effect of the disclosure is that the camouflage pattern can be actively changed during operation in the infrared range, and thus it is possible to avoid detection of infrared signals and shape analysis by the developed Image IR technology.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an image of a camouflage pattern implemented in a visible region by a sheet according to an embodiment of the disclosure;

FIG. 2 is an image of a camouflage pattern implemented in visible and infrared regions by a sheet according to an embodiment of the disclosure;

FIGS. 3 and 4 are graphs and images showing color change in a visible region according to block thickness according to an embodiment of the disclosure;

FIG. 5 is a graph showing color change in an infrared region according to block thickness and temperature according to an embodiment of the disclosure; and

FIG. 6 is an image showing a temperature-dependent camouflage pattern of a sheet according to an embodiment of the disclosure and a temperature-specific camouflage pattern of a conventional sheet.

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a component, this does not mean that it excludes other components, unless otherwise specifically stated, but rather that it may include other components.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

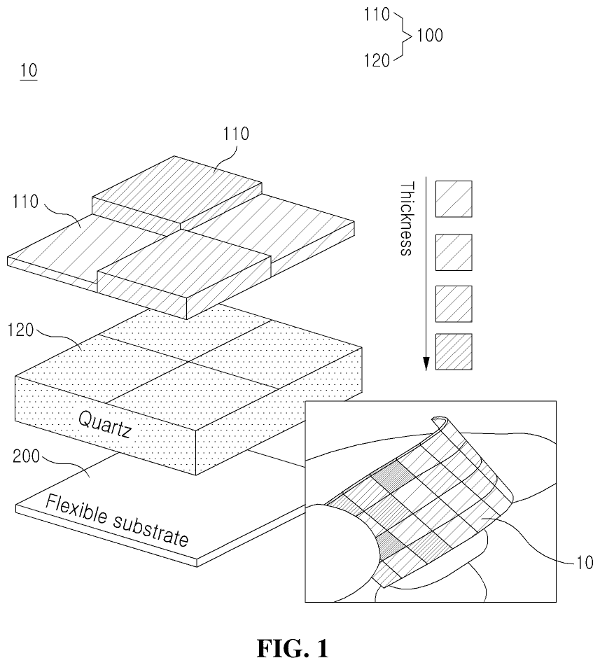

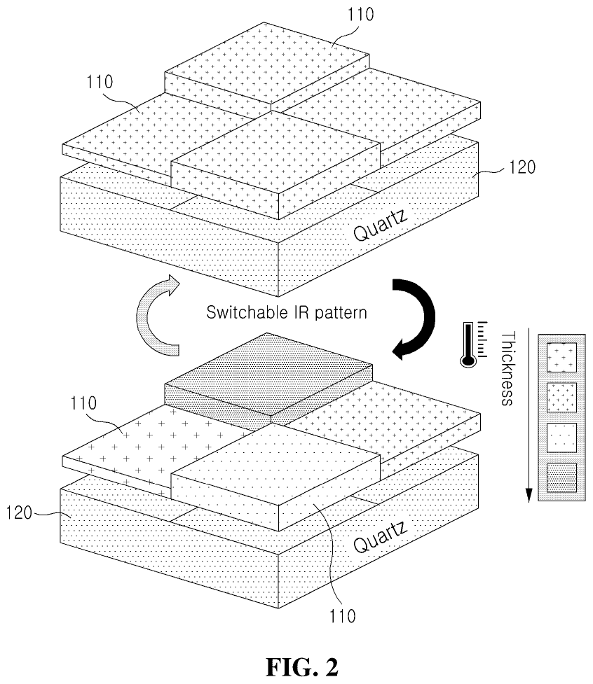

FIG. 1 is an image of a camouflage pattern implemented in a visible region by a sheet (10) according to an embodiment of the disclosure, and FIG. 2 is an image of a camouflage pattern implemented in a visible region and an infrared region by a sheet (10) according to an embodiment of the disclosure.

Here, the upper image of FIG. 2 is an image of a camouflage pattern implemented in the visible region below the transition temperature of blocks (110), and the below image of FIG. 2 is an image of a camouflage pattern implemented in the infrared region above the transition temperature of the blocks (110).

That is, depending on the temperature of the blocks (110), the sheet (10) of the disclosure may be expressed after switching between the camouflage pattern in the visible region and the camouflage pattern in the infrared region. Hereinafter, this will be described in detail.

The sheet (10) of the disclosure includes: blocks (110) formed of vanadium oxide; and a substrate (120) formed under the blocks (110). Here, the plurality of blocks (110) may form a camouflage pattern.

Here, vanadium dioxide (VO₂) may be used as the vanadium oxide.

Vanadium dioxide is a phase-change material of which electrical properties change by more than 5,000 times depending on temperature. Since vanadium dioxide exhibits variable infrared radiation signals depending on its thickness and temperature, the infrared radiation signals of the blocks (110) formed of vanadium dioxide can be actively controlled by adjusting its thickness and temperature, thereby facilitating the implementation of a camouflage pattern.

Furthermore, the reflectivity in the visible region varies depending on the thickness of the blocks (110), thereby creating a color difference in the blocks (110), and this facilitates the implementation of a camouflage pattern even in the visible region.

The sheet (10) of the disclosure may include a base plate (200) formed under the substrate. The substrate (120) may be formed of quartz, aluminum oxide (Al₂O₃), or silicon dioxide (SiO₂).

However, the material of the substrate (120) is not limited to this, and other materials that stably support the blocks (110) may be used.

The upper surface of the blocks (110) may be formed in various shapes, such as a polygon, circle, or oval, and the upper and lower surfaces of the block (110) may have the same shape, wherein the upper surface of the substrate (120) supporting the blocks (110) may be formed in a shape corresponding to the lower surface of the blocks (110).

One substrate (120) may support one block (110), and a combination of one substrate (120) and one block (110) forms one tile (100); a plurality of tiles (100) formed in this manner may be placed on the base plate (200).

At this time, each of the plurality of substrates (120) may have the same thickness. Furthermore, depending on the shape of the camouflage pattern, one block (110) among the plurality of blocks (110) may have different thicknesses from another block (110), or one block (110) and another block (110) among the plurality of blocks (110) may have the same thickness.

Accordingly, the thicknesses of the plurality of blocks (110) may vary, and camouflage patterns using the plurality of blocks (110) may also vary.

However, while an embodiment of the disclosure describes the thicknesses of a plurality of substrates (120) as being equal, the thicknesses of one substrate (120) and another substrate (120) may differ to implement the camouflage pattern.

The base plate (200) may be formed of a flexible material. As described above, since the plurality of tiles (100) are formed separately from each other and arranged in a camouflage pattern on the upper surface of the base plate (200), even if the base plate (200) is bent, each of the plurality of tiles (100) can be easily secured to the surface of the base plate (200).

Furthermore, to generate an infrared radiation signal as described above, the lower surface of the base plate (200) may be heated; thus, the base plate (200) may be formed of a heat-resistant polymer material, etc., which prevents deformation due to heating while maintaining flexibility, and consequently, the sheet (10) of the disclosure may be flexible.

As described above, since having flexibility, the sheet (10) of the disclosure can be easily applied not only to flat surfaces but also to curved surfaces of an attachment target.

When the temperature of the plurality of blocks (110) is below the transition temperature, colors of one block (110) and another block (110) among the plurality of blocks (110) may differ from each other.

Specifically, the temperature of the plurality of blocks (110) being below the transition temperature of the blocks (110) means that the plurality of blocks (110) implement a camouflage pattern in the visible region. At this time, the respective blocks (110) each having different thicknesses have different reflectivities of light in the visible region, resulting in different colors for each of the blocks (110), which can be utilized to easily implement a camouflage pattern.

When the temperature of the plurality of blocks (110) is equal to or above the transition temperature, the infrared radiation signals of one block (110) and another blocks (110) among the plurality of blocks (110) may differ from each other.

Specifically, the temperature of the plurality of blocks (110) being higher than the transition temperature of the blocks (110) means that the plurality of blocks (110) implement a camouflage pattern in the infrared region, and at this time, heating of the sheet (10) of the disclosure can be performed.

In this case, among the blocks (110) having different thicknesses, each of the blocks (110) having different thicknesses generates a different infrared radiation signal. Accordingly, at the corresponding temperature, the colors of the blocks (110) having different thicknesses are formed differently, and this can be used to easily implement a camouflage pattern.

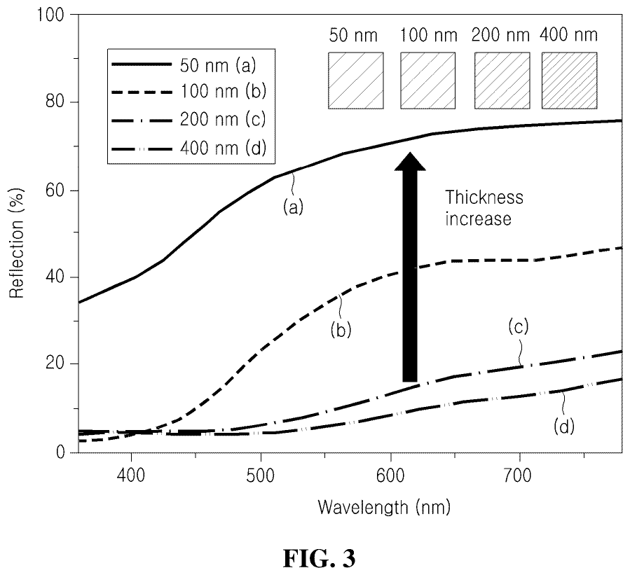

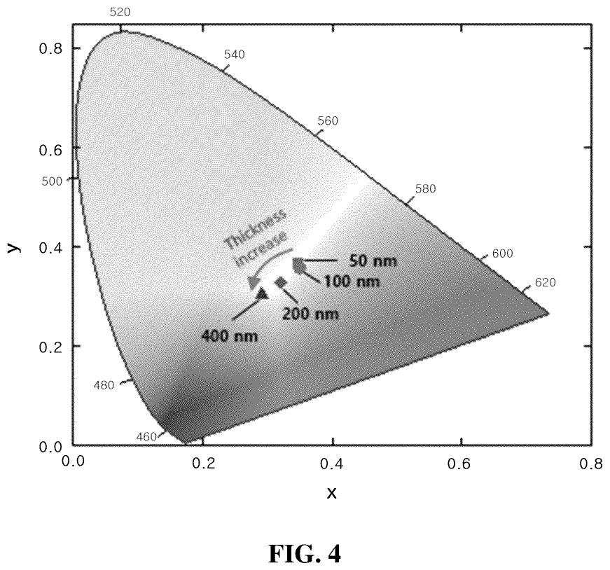

FIGS. 3 and 4 are graphs and images showing color change in a visible region according to the thickness of blocks (110) according to an embodiment of the disclosure.

Specifically, FIG. 3 is a graph showing reflectance at each wavelength in a visible region according to the thickness of blocks (110), and FIG. 4 is a graph showing color change according to the thickness of blocks (110) in a color reproduction area (CIE graph).

As shown in FIGS. 3 and 4, as the thickness of the block (110) increases, the reflectance in the visible region (350 nm to 780 nm) may decrease. Furthermore, when the block (110) is relatively thin, the reflectance of red and green light is high, so the observed color is primarily brown; however, as the block (110) becomes thicker, the red and green light decreases rapidly, resulting in observed colors of dark brown and dark gray.

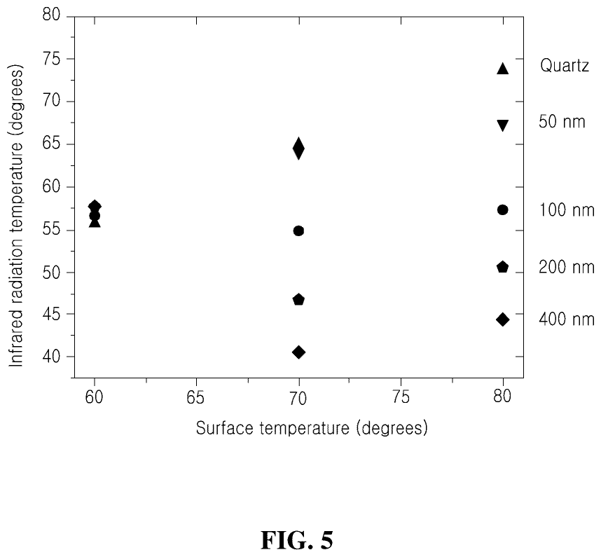

FIG. 5 is a graph showing infrared discoloration according to the thickness and temperature of blocks (110) according to an embodiment of the disclosure. Here, dots with different shapes may represent blocks (110) with different thicknesses.

FIG. 5 shows the intensity of an infrared signal according to the thickness of blocks (110) formed of vanadium dioxide, and the infrared signal was measured as infrared radiant temperature.

As shown in FIG. 5, at 60° C., there is no difference in infrared signal intensity depending on vanadium dioxide thickness. However, at temperatures higher than the transition temperature (70° C. and 80° C.), a deviation in infrared radiant temperature of more than 25° C. can be observed.

That is, it can be confirmed that in the infrared region, when the temperature of the block (110) is lower than the transition temperature of vanadium dioxide (67° C.), it has a uniform infrared radiation intensity, but as the temperature increases, the thicker the block (110) is, the lower the radiation intensity is.

Therefore, differences in infrared signal intensity due to the thickness of the blocks (110) generate differences in infrared signal intensity, enabling the implementation of an infrared camouflage pattern using the plurality of blocks (110).

Furthermore, when the temperature of the blocks (110) drops below the transition temperature, the infrared camouflage pattern disappears, allowing the infrared camouflage pattern to be actively switched to a visible-range camouflage pattern.

That is, by attaching the sheet (10) of the disclosure to a region where temperature varies, camouflage patterns can be implemented in both the visible and infrared regions, depending on the temperature.

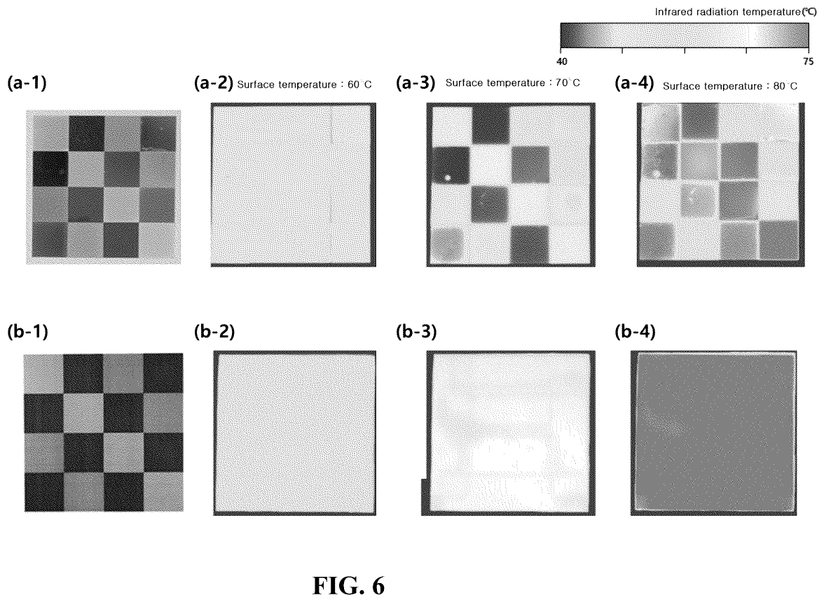

FIG. 6 is an image showing a temperature-dependent camouflage pattern of a sheet according to an embodiment of the disclosure and a temperature-specific camouflage pattern of a conventional sheet.

Specifically, (a-1) of FIG. 6 illustrates the sheet (10) of the disclosure, (a-2) of FIG. 6 illustrates an image of the sheet (10) of the disclosure when the surface temperature is 60° C., (a-3) of FIG. 6 illustrates an image of the sheet (10) of the disclosure when the surface temperature is 70° C., and (a-4) of FIG. 6 illustrates an image of the sheet (10) of the disclosure when the surface temperature is 80° C.

In addition, (b-1) of FIG. 6 illustrates a conventional sheet using a typical dye-based camouflage pattern, (b-2) of FIG. 6 illustrates an image of the sheet surface at 60° C., (b-3) of FIG. 6 illustrates an image of the sheet surface at 70° C., and (b-4) of FIG. 6 illustrates an image of the sheet surface at 80° C.

As shown in (a-1) to (a-4) of FIG. 6, when blocks (110) are formed with different thicknesses to form a camouflage pattern, the infrared radiation intensity varies for each tile (100) at high temperatures, resulting in an infrared camouflage pattern being observed by a detector.

However, as shown in (b-1) to (b-4) of FIG. 6, in the case of a typical dye-based camouflage pattern, the infrared signal increases consistently for each color as the temperature increases.

Using the sheet (10) of the disclosure for active infrared radiation control, as described above, can be applied not only to infrared camouflage but also to smart energy coatings for active heat management, where infrared absorption is controlled according to temperature, taking advantage of the fact that emissivity and absorption are equal due to Kirchhoff's law.

Furthermore, as shown in FIG. 6, in a temperature range equal to or above the transition temperature of the blocks (110), the color arrangement of the camouflage pattern by the multiple blocks (110) can change with temperature changes, and this allows for the formation of different camouflage patterns at each temperature, enhancing the camouflage effect.

As described above, when using the sheet (10) of the disclosure, the infrared pattern can be changed in real time based on temperature, and simultaneously, the camouflage pattern can be implemented in the visible range through color change characteristics depending on thickness, significantly enhancing the camouflage effect in each optical region.

Furthermore, since the camouflage pattern can be actively changed during operation in the infrared range, as described above, it is possible to avoid detection of infrared signals and shape analysis by the developed Image IR technology.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

### EXPLANATION OF REFERENCE NUMERALS

10: sheet of the disclosure
100: tile
110: block
120: substrate
200: base plate

What is claimed is:

1. A temperature-sensitive infrared radiation active control sheet, comprising:
a plurality of blocks formed of vanadium oxide; and
a substrate disposed under the plurality of blocks,
wherein at least one pair of blocks among the plurality of blocks has different thicknesses from each other.

2. The temperature-sensitive infrared radiation active control sheet of claim 1, wherein the plurality of blocks are configured to define a camouflage pattern.

3. The temperature-sensitive infrared radiation active control sheet of claim 1, wherein at least one pair of blocks among the plurality of blocks have a same thickness.

4. The temperature-sensitive infrared radiation active control sheet of claim 1, wherein a thickness of each of the plurality of blocks is in a range of 50 to 400 nanometers (nm).

5. The temperature-sensitive infrared radiation active control sheet of claim 1, wherein when a temperature of the plurality of blocks is equal to or higher than a transition temperature, infrared radiation signals of at least one pair of blocks among the plurality of blocks are different from each other.

6. The temperature-sensitive infrared radiation active control sheet of claim 1, wherein when a temperature of the plurality of blocks is lower than a transition temperature, colors of at least one pair of blocks among the plurality of blocks are different from each other.

7. The temperature-sensitive infrared radiation active control sheet of claim 1, wherein depending on a temperature of the plurality of blocks, a camouflage pattern in a visible area and a camouflage pattern in an infrared area are switched and expressed.

8. The temperature-sensitive infrared radiation active control sheet of claim 1, wherein the substrate is formed of quartz, aluminum oxide (Al₂O₃) or silicon dioxide (SiO₂).

9. The temperature-sensitive infrared radiation active control sheet of claim 1, further comprising a base plate disposed under the substrate.

10. The temperature-sensitive infrared radiation active control sheet of claim 9, wherein the base plate is formed of a flexible material.

11. The temperature-sensitive infrared radiation active control sheet of claim 9, wherein a combination of one substrate and one block is formed, and a plurality of combinations are disposed on the base plate.

12. The temperature-sensitive infrared radiation active control sheet of claim 1, wherein a surface shape of the plurality of blocks includes a polygon, circle or ellipse.
